(19) United States
(12) Patent Application Publication
(10) Pub. No.: US 2016/0044905 A1
(43) Pub. Date: Feb. 18, 2016

(54) LINE-WRAPPED FISH HOOK AND LURE ADAPTER

(71) Applicant: RONALD W. BASKETT, SAN BERNARDINO, CA (US)

(72) Inventor: RONALD W. BASKETT, SAN BERNARDINO, CA (US)

(21) Appl. No.: 14/461,797

(22) Filed: Aug. 18, 2014

(51) Int. Cl. A01K 91/04; A01K 91/047

(52) U.S. Cl. CPC A01K 91/04; A01K 91/047

(57) ABSTRACT

A hook adapter for attaching a fish hook or lure to a fishing line without tying a knot is described. The hook adapter includes a wire having a first end wrapped into at least two coils that form a cylindrically coiled eye and an inlet guide between a first end of the wire and a first coil, an elongated body, a bend connecting the cylindrically coiled eye to the body, and a second end that is formed into a conic spiraled eye having a gap between the second end of the wire and an adjacent spiral. The hook adapter further includes a protrusion that is disposed on body. The body has sufficient space to wrap a fishing line multiple times around the body between the protrusion and the conic spiraled eye.

### FIELD OF THE INVENTION

The presently disclosed subject matter is directed to adapters for attaching fish hooks and fishing lures to fishing lines. More particularly it is directed towards an improved line-wrapped, fish hook and lure adapter.

### BACKGROUND OF THE INVENTION

Without any doubt fishing has been and remains one of the most popular recreational actives around the world. Fishing can be performed not only for recreation but also as a sport and as a means of obtaining food.

There are numerous ways to fish. For example hand gathering such as noodeling, spearing, shooting, netting, and trapping, as well as the more exotic methods of explosives and draining ponds and lakes. But recreational fishing is primarily performed using artificial lures and/or fish hooks having either live or artificial bait which are connect to a fishing line on a fishing pole. As has been well established and widely documented by legions of fisherman over generations attaching hooks or lures to a fishing line can be difficult and time consuming. When done improperly it may lead to the loss of fish, lures, hooks, and bait. This is particularly true in foul weather, when bouncing around in a boat, when using thin fishing lines, or when attempted by fisherman with poor eyesight or poor hand/eye coordination. Fishermen are rather routinely cut, impaled or otherwise injured while attempting the supposedly simple task of attach a hook or lure to a fishing line.

Complicating the supposedly simple task of attaching fishing hooks and lures to fishing lines is the need or desire to change hooks and lures often. Since fish are notoriously finicky about what they will or will not attack at any given time in any given environment the need to experiment with many different lures and hook-bait combinations to arrive at an effective bait system can be very important. For example, at times live bait can be highly effective while minutes later lures may be better. A seemingly minor change in a fish bait system can dramatically improve or reduce the number of fish caught in a given amount of time. Furthermore, what is effective one day may be counterproductive the next and thus a fisherman is reduced to starting all over to develop the proper fish bait system.

Thus there exists a need for a device that increases the speed and improves the ease of attaching a fishing lure or hook to a fishing line. Preferably such a device would provide a simple to use attachment by which a fisherman can quickly and easily remove a fishing lure or hook and then quickly and easily attach another fishing lure or hook, even during foul weather, when bouncing around in a boat, or when using thin fishing line. Ideally such a device would be usable by fisherman with poor eyesight or poor hand/eye coordination. Such a device would be particularly beneficial if it helped reduce fishing injuries and the frustration associated with attempting to tie knots.

### BRIEF SUMMARY OF THE INVENTION

The principles of the present invention provide for an easy to use fish hook adapter that increases the speed of connecting and removing fishing lures and/or fishing hooks to and from fishing lines. The inventive hook adapter is simple to use and is particularly beneficial during foul weather, when bouncing around in a boat, or when using thin fishing line. The hook adapter can be used by fisherman with poor eyesight or poor hand/eye coordination, reduces fishing injuries, and does not require knot tying.

A hook adapter in accord with the present invention includes a wire having a first end that is wrapped into coils to form a cylindrically coiled eye lying in a plane. The first end terminates in an inlet guide formed between the very end of the wire and a coil of the cylindrically coiled eye, with that very end extending from a coil. The hook adapter wire further includes an elongated body, a bend connecting the cylindrically coiled eye to the body, and a second end that is formed into a conic spiraled eye having a gap between adjacent spirals and in which the conic spiraled eye is twisted to lie in a different plane than that of the cylindrically coiled eye. The hook adapter further includes a protrusion that is disposed on the body. The body is long enough to wrap a fishing line around the body between the protrusion and the conic spiraled eye.

In practice the cylindrically coiled eye has circular coils. The cylindrically coiled eye can receive a hook device by passing the hook device eye into the inlet guide and then rotating the hook device around the coils. The cylindrically coiled eye preferably extends along an axis of the body. The inlet guide extends forward from a coil and the inlet guide forms an entry path into the cylindrically coiled eye. The cylindrically coiled eye can be configured to receive a lure. Beneficially, the axis passes through the cylindrically coiled eye.

The axis may also pass through the conic spiraled eye, and the conic spiraled eye may spiral along the axis so as to approach the axis as one moves away from the protrusion. In that case, the axis might pass through the cylindrically coiled eye. In any event the protrusion should be high enough to retain the loop of a fishing line. Beneficially the protrusion is a ball located closer to the conic spiraled eye than to the cylindrically coiled eye. The protrusion may be welded to the body.

### BRIEF DESCRIPTION OF THE DRAWINGS

The advantages and features of the present invention will become better understood with reference to the following detailed description and claims when taken in conjunction with the accompanying drawings, in which:

FIG. 1 is a perspective view of a hook adapter 10 that is in accord with the principles of the present invention; and

FIG. 2 is another perspective view of the hook adapter 10 shown in FIG. 1 but rotated slightly.

### DETAILED DESCRIPTION OF THE INVENTION

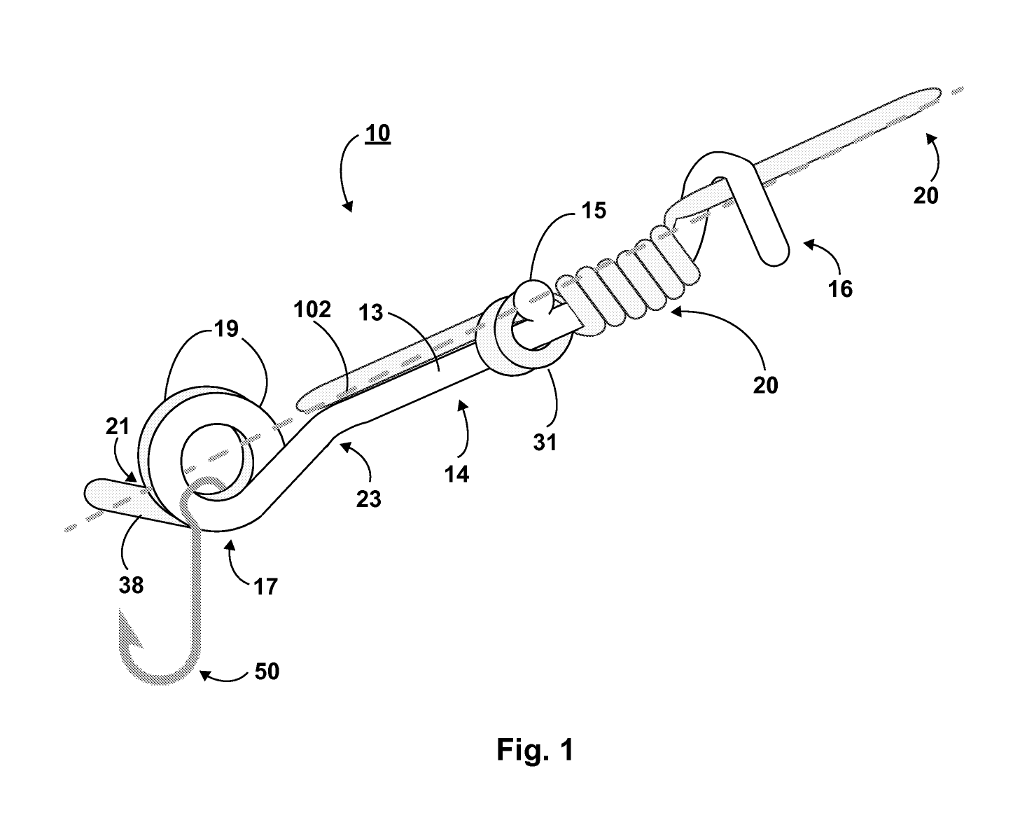

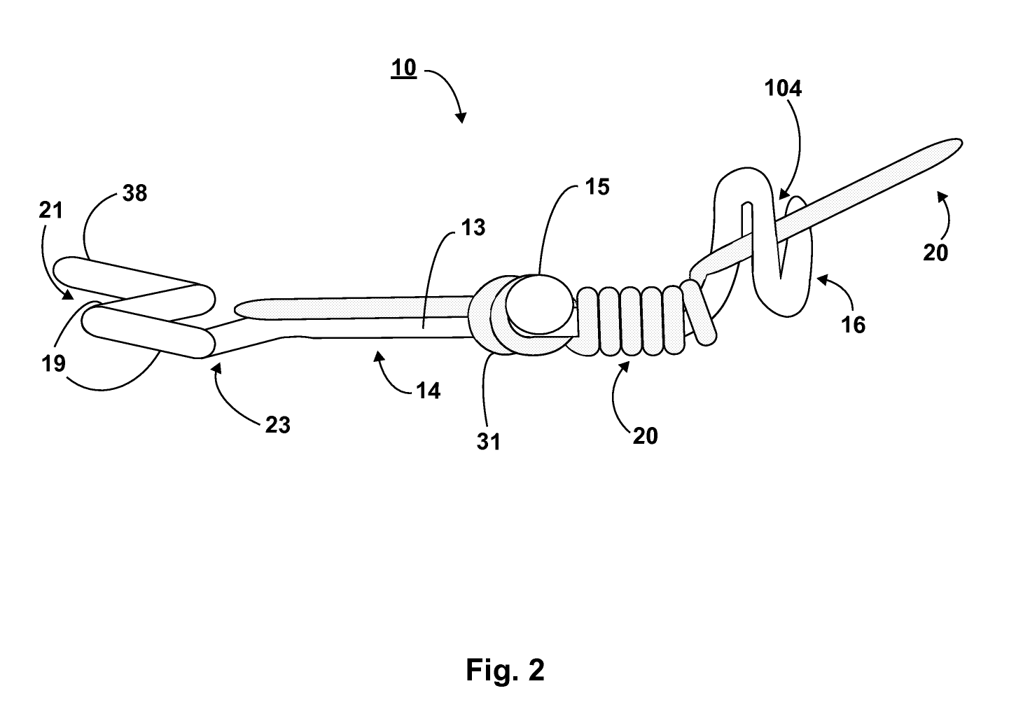

The preferred embodiment of the present invention is a hook adapter 10 as depicted in FIGS. 1 and 2. However, the invention is not limited to the specifically described and illustrated embodiment. A person skilled in the art will appreciate that many other embodiments of the invention are possible without deviating from the basic concept of the invention. Any such work around will also fall under the scope of the appended claims.

In the figures like numbers refer to like elements throughout. Additionally, the terms “a” and “an” as used herein do not denote a limitation of quantity, but rather denote the presence of at least one of the referenced items. Unless otherwise indicated all directional signals such as left, right, up, down, in and out are taken relative to the orientation shown in FIG. 1.

Referring now to FIGS. 1 and 2, the present invention is a hook adapter 10 that enables easy, rapid, and secure attachment and subsequent removal of a hook device 50 to and from a fishing line 20 without tying a knot. While the hook device 50 is shown generically as a simple barbed hook, that is only for convenience. The hook device 50 may be a simple hook, a more complex hook, a fishing lure, or any other device to be attached to a fishing line.

The hook adapter 10 includes a wire 14 that forms an elongated body 13 which generally runs along an axis 102. In practice the body 13 may be slightly curved as a result of manufacturing and manufacturing variations. A small protrusion 15, shown as a ball, protrudes from the body 13 at a location that is to the right of the mid-point of the body 13. In practice the protrusion 15 is spot welded to the body 13.

The left end of the body 13 curves downward into a bend 23. The left end of the wire 14 is wrapped into circular coils 19 to form a cylindrically coiled eye 17. The cylindrically coiled eye 17 lies in a plane that is generally parallel with the axis 102. The very end 38 of the wire 14 extends out from a coil 19 to form an inlet guide 21.

The right end of the wire 14 is twisted around from the body 13 and formed into a conic spiraled eye 16 that spirals substantially along the axis 102. The conic spiraled eye 16 resembles an extended pig's tail with the distances between the spiral body and the spiral axis declining as one moves away from the protrusion 15. Preferably, the axis 102 passes through both the conic spiraled eye 16 and the cylindrically coiled eye 17. The end of the conic spiraled eye 16 forms a gap 104 with its nearest spiral neighbor. That is, the spirals of the conic spiraled eye 16 do not touch.

The conic spiraled eye 16 receives the fishing line 20. That fishing line 20 is formed into a loop 31 which is looped over the protrusion 15. The protrusion 15 extends far enough from the body 13 that the fishing line 20 loop 31 is caught by the protrusion 15. Then, the “doubled” over fishing line 20 end that results from forming the loop 31 is wrapped around the body 13 between the protrusion 15 and the conic spiraled eye 16. Then that end of the “doubled” fishing line 20 is wrapped on the other side of the protrusion and left to dangle while the main body of the fishing line 20 is wrapped over the dangling end to hold it in place. The main body of the fishing line 20 is then wrapped several times over the body 13 between the protrusion 15 and the conic spiraled eye 16 and is then passed through the conic spiraled eye 16 and out the gap 104. The fishing line 20 is then cinched to the body 13 by pulling.

To attach the hook device 50 the cylindrically coiled eye 17 the hook device 50 eye is inserted along the inlet guide 21 and into its adjacent coil 19. The eye of the hook device 50 is then rotated along the coils 19 by turning until it falls into the cylindrically coiled eye 17. To remove the hook device 50 it is simply moved back along the coils 19 by turning until it can be removed along the inlet guide 21.

It is envisioned that other styles and configurations of the present invention can be easily incorporated into the teachings of the present invention. While only one particular configuration is shown and described that is for purposes of clarity and disclosure and not by way of limitation of scope. The foregoing descriptions of the present invention are not intended to be exhaustive or to limit the invention to the precise forms disclosed. Obviously many modifications and variations are possible in light of the above teaching.

What is claimed:

1. A hook adapter, comprising:
a wire with a first end wrapped into coils to form both a cylindrically coiled eye and an extending lead that produces an inlet guide into a coil, an elongated body, a bend connecting said cylindrically coiled eye to said body, and a second end that is formed into a conic spiraled eye having a gap between the tip of the wire and an adjacent spiral; and
a protrusion disposed on said body;
wherein a fishing line can be wrapped around said body between said protrusion and said conic spiraled eye at least twice.

2. The hook adapter according to claim 1, wherein said cylindrically coiled eye is a circularly cylindrically coiled eye.

3. The hook adapter according to claim 1, wherein said cylindrically coiled eye can receive a hook device by passing a hook device eye into said inlet guide and rotating the hook device around said coils.

4. The hook adapter according to claim 1, wherein said cylindrically coiled eye is parallel to an axis of said body.

5. The hook adapter according to claim 1, wherein said extending end extends forward from a coil.

6. The hook adapter according to claim 4, wherein said inlet guide forms an entry path into said cylindrically coiled eye.

7. The hook adapter according to claim 6, wherein said cylindrically coiled eye is configured to receive a lure.

8. The hook adapter according to claim 4, wherein said axis passes through said cylindrically coiled eye.

9. The hook adapter according to claim 4, wherein said axis passes through said conic spiraled eye.

10. The hook adapter according to claim 4, wherein said conic spiraled eye narrows as the distance from said protrusion increases.

11. The hook adapter according to claim 10, wherein said axis passes through said cylindrically coiled eye.

12. The hook adapter according to claim 1, wherein said protrusion is high enough to retain a loop of a fishing line.

13. The hook adapter according to claim 12, wherein said protrusion is a ball.

14. The hook adapter according to claim 13, wherein said protrusion is located closer to said conic spiraled eye than to said cylindrically coiled eye.

15. The hook adapter according to claim 13, wherein said protrusion is welded to said body.
